(19) United States
(12) Patent Application Publication
(10) Pub. No.: US 2012/0037453 A1
(43) Pub. Date: Feb. 16, 2012

(54) Collapsible ladder and method

(76) Inventor: Francisco Flecha, Chicago Heights, IL (US)

(21) Appl. No.: 12/806,520

(22) Filed: Aug. 16, 2010

(51) Int. Cl. E06C 1/383; E06C 1/10; E06C 1/06

(52) U.S. Cl. 182/159

(57) ABSTRACT

The present invention provides a significant improvement to a ladder by making it light-weight and easily collapsible. Ladder rails slide back and forth over ladder rungs allowing the ladder to collapse to a fraction of its extended size. After collapse of the rails, the rungs fold up using a pivoting knuckle hinge. The pivot is specifically designed to pivot only one way to prevent accidents or collapse while the ladder is in use. This design allows the ladder to be compact and easily transportable. Similarly, the materials used to construct the ladder make it light-weight enough for most adults to carry easily.

### 1. FIELD OF THE INVENTION

Embodiments of the present invention are related to a collapsible ladder. More specifically, embodiments of the present invention provide a collapsible ladder and a method for collapsing a ladder, or the like.

### 2. BACKGROUND OF THE INVENTION

Standard ladders, while once necessary, have several significant flaws that are well known to anyone skilled in the art. Standard ladders are bulky, heavy and difficult to store and transport. A conventional ladder can never be made smaller or less heavy and by virtue of this takes up considerable space even when not in use.

Past attempted remedies of these flaws have only partially succeeded. For example, U.S. Pat. No. 4,884,659 provides for a ladder that is collapsible by folding each H-shaped segment up. While this does succeed in collapsing the ladder, it leads to another potentially serious problem when the ladder is in operation because there are numerous parts that could fail and cause the ladder to collapse while in use. Similarly, U.S. Pat. No. 5,158,151 provides for a collapsible ladder that folds bi-directionally. This ladder has the same downfall as U.S. Pat. No. 4,884,659.

The present invention remedies all of these flaws. It is light-weight, easily and fully collapsible and easy to use and transport. It also remedies safety issues in its design. This invention remedies this issue by collapsing the ladder in a different way so that there is no concern about failed parts leading to injury while the ladder is in use. To make this invention further portable, the ladder can be broken down into five-foot sections for easy transport.

### SUMMARY OF THE INVENTION

Accordingly, the present invention provides a fully collapsible ladder comprising two solid rails, solid rungs, pivoting knuckle hinges and barrel hinges. In a preferred embodiment, the barrel hinges attach one rail to the solid rungs which allow the second rail to slide over the rungs to open and collapse the ladder. In the open, operable position the second rail is slid over the rungs and allows the user to use the ladder in a normal conventional way. When the user is finished the second rail is slid back over the rungs to abut the first rail and the rungs are folded up using the knuckle hinge to fully collapse the ladders parts into one compact position. The specially designed knuckle hinges only operate in one direction to ensure that the rungs will only move in one direction and prevent the rungs from collapsing while the ladder is in use. Each ladder section will be of consistent size and be able to be connected to and mounted on another section of ladder using a barrel hinge and pressure locking pin. This will allow the ladder to be elongated and shortened quickly.

These provisions, together with the various ancillary provisions and features which will become apparent to those skilled in the art as the following description proceeds, are attained by the collapsible ladder and methods of the present invention.

### BRIEF DESCRIPTION OF THE DRAWINGS

FIG. 1 is a perspective view of the ladder in its preferred embodiment when activated for use.

FIG. 2 is a similar to FIG. 1 showing how the ladder operates and how the knuckle fits in the rung.

FIG. 3 is a view similar to FIG. 1 showing the railing sliding over the rung as the ladder begins to collapse.

FIG. 4 is a view similar to FIG. 1 showing the ladder fully collapsed.

FIG. 5 is an enlarged view of the knuckle attached to the rung and the railing showing the rung is use.

FIG. 6 is an enlarged view of the knuckle attached to the rung and the railing showing the rung folded up as it would be if the ladder was collapsed.

FIG. 7 is an enlarged view of the movable rail abutting the rung's enlarged knob and showing the optional magnetized metal cuff that fits over the rung to secure the movable rail.

FIG. 8 is an enlarged view of the optional magnetized metal cuff sliding over the rung and coming into contact with the magnetized enlarged knob at the end of the rung securing the movable rail.

### DETAILED DESCRIPTION OF EMBODIMENTS OF THE INVENTION

In the description herein, numerous specific details are provided, such as examples of components and/or methods, to provide a thorough understanding of the embodiments of the present invention. One skilled in the relevant art will recognize, however, that an embodiment of the invention may be practiced without one or more of the specific details, or with other apparatus, systems, assemblies, methods, components, materials, parts, and/or the like. In other instances, well-known structures, materials, or operations are not specifically shown or described in detail to avoid obscuring aspects of the embodiments of the present invention.

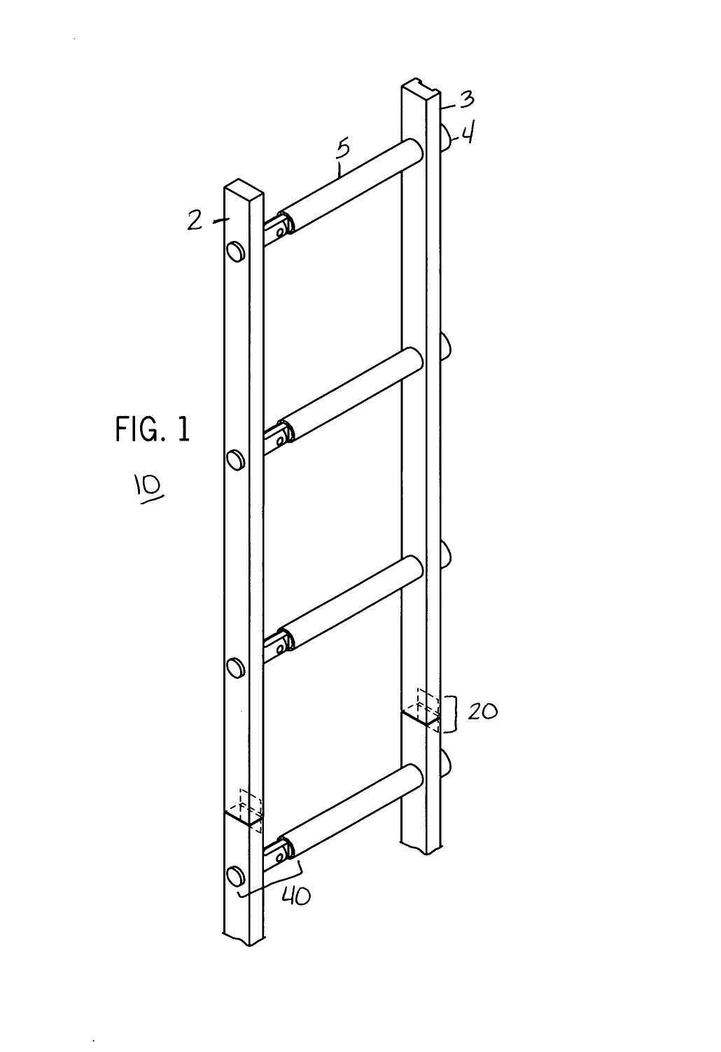

Referring in detail now to the drawings, wherein similar parts of the invention are identified by like reference numerals, there is seen a collapsible ladder 10 in accordance with the present invention and generally comprises the first stable or non-movable rail 2 that is affixed to the knuckle mechanism 40. As shown enlarged in FIG. 1, a second movable rail 3, rungs of ladder 5 and a hinge mechanism 20 allow the ladder sections to more fully collapsed or expanded. The ladder 10 can generally be formed from metal, composite resin, wood, bamboo or aluminum alloy. The knuckle mechanism 40 can be formed from metal or aluminum alloy.

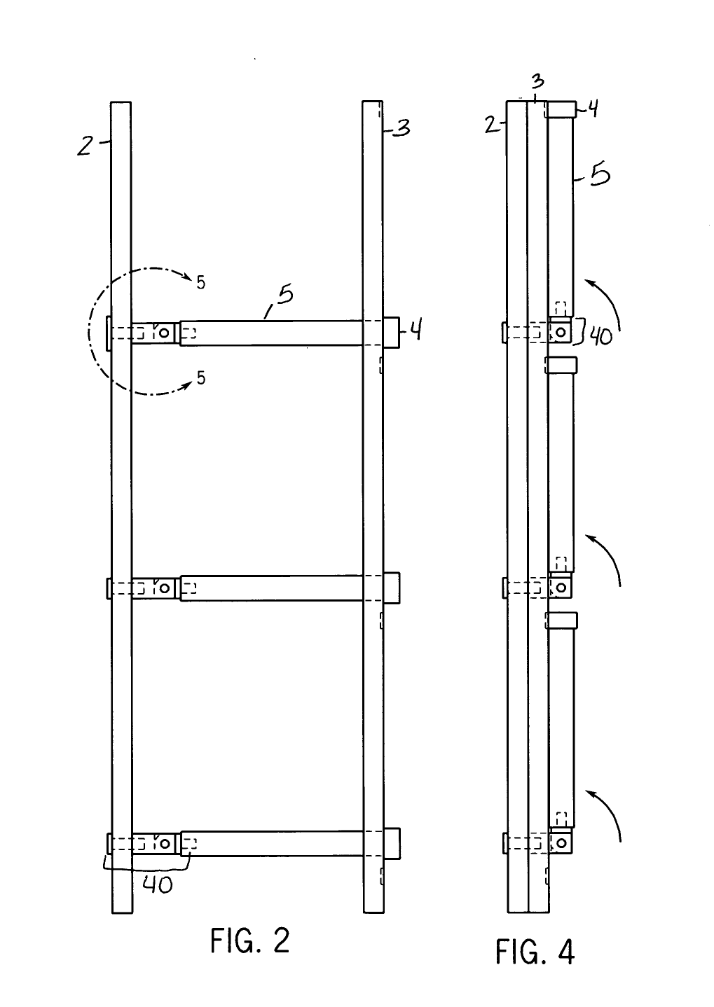

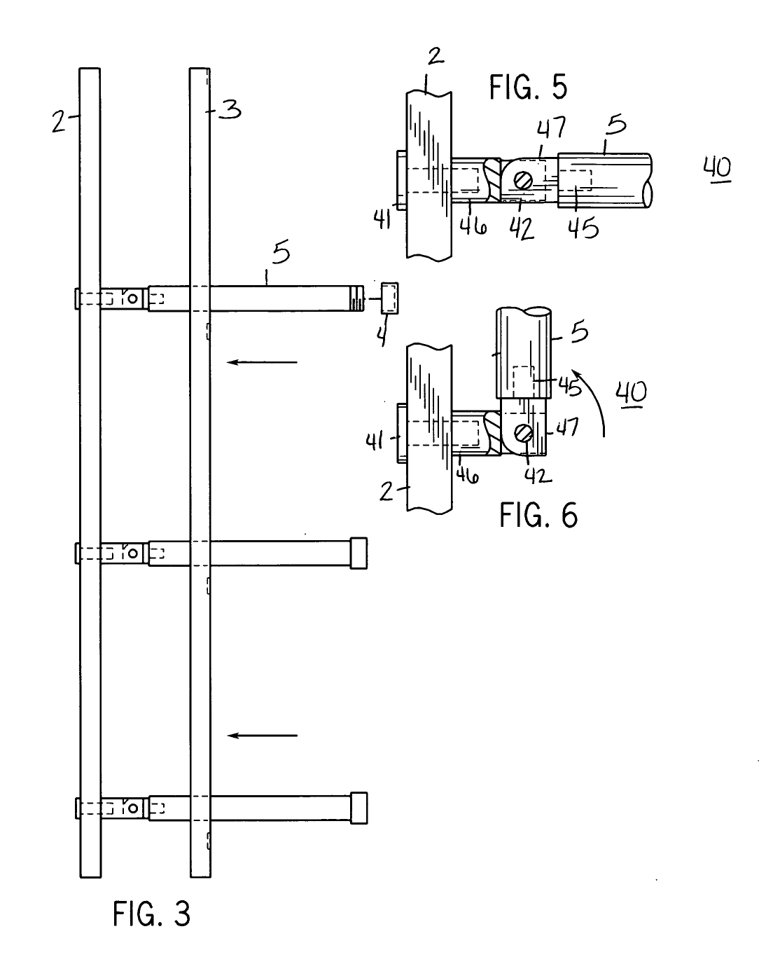

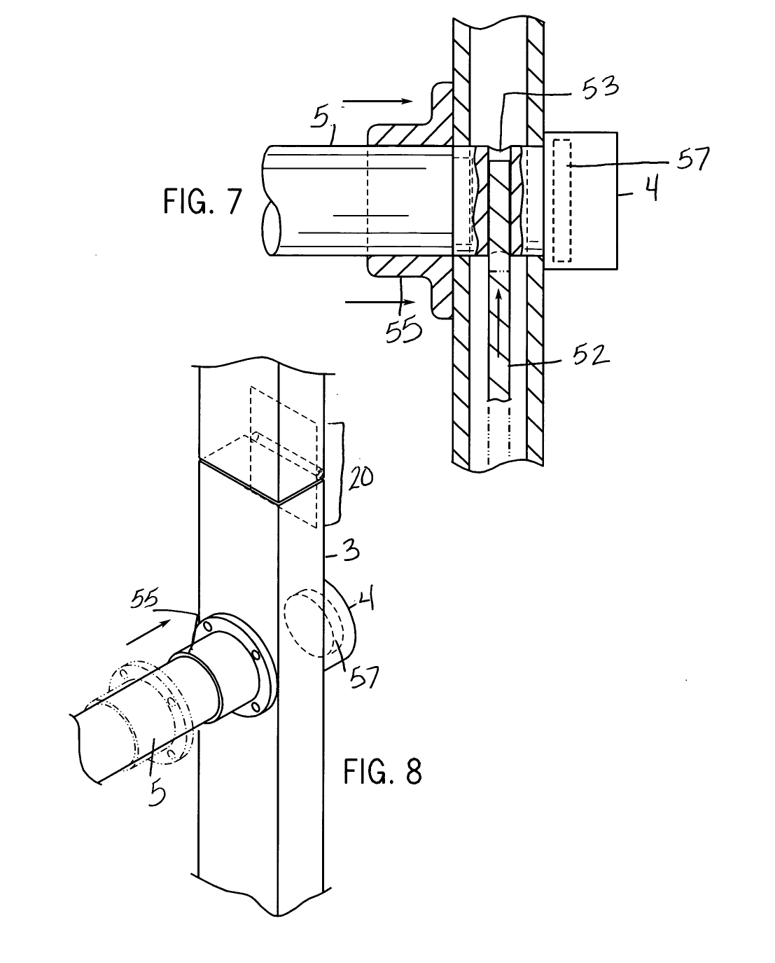

With further reference to FIG. 2, a frontal view of the collapsible ladder 10 with the movable rail 3 fully expanded and the ladder in operable position. When movable rail 3 is expanded fully over rungs 5, movable rail 3 abuts to flange 4 such that movable rail 3 is secure and unable to dislodge from rungs 5. In one embodiment, moveable rail 3 may be slid manually by the user over rung 5 until it abuts flange 4 and falls into or slides into a depressed groove to further prevent movable rail 3 from moving during use of ladder 10. In another embodiment, movable rail 3 may also be secured in the operable position when a moveable magnetized cuff 55 is used on moveable rail 3 such that the moveable magnetized metal cuff 55 is manually placed abutting a magnetized flange 4 as shown in FIG. 7 and FIG. 8. With further reference to FIG. 3, a frontal view of ladder 10 showing the movable rail 3 engaged in sliding over rung 5 toward stable rail 2 and knuckle mechanism 40.

With further reference to FIG. 4, the ladder 10 is in collapsed position with movable rail 3 abutting stable rail 2 with the knuckle mechanism 40 engaged such that rungs 5 may fold up directionally. When the ladder 10 is fully collapsed rails 2 and 3 abut one another such that rail 3 is in contact with both rail 2 and over the non-pivoting part 46 of knuckle mechanism 40 as shown in FIG. 5 and FIG. 6. When rails 2 and 3 are in contact, the knuckle mechanism engages and allows the pivoting portion 47 of knuckle mechanism 40 to pivot or swivel upwards moving the rungs 5 into contact with movable rail 3.

With reference to FIGS. 5 and 6, the knuckle mechanism 40 is affixed to the stable rail 2 by insertion through an inlet in rail 2 such that the knuckle knob 41 is abutting stable rail 2. The knuckle mechanism is then affixed to rung 5 by securing mechanism 45 which inserts into rung 5. Knuckle mechanism 40 allows one-directional movement of rung 5 upwards using the swivel mechanism 42. To engage the knuckle 40 the pivot 42 engages and moves the pivoting portion 47 upright such that it can fold the rung 5 upwards and abutting the moveable rail 3. When engaged the pivoting portion 47 of the knuckle mechanism is pivoted upward using the pivot or hinge 42 such that the rungs 5 move upwards and into contact with movable rail 3. When engaged the non-pivoting portion 46 of the knuckle mechanism is in contact with the moveable rail 3.

With reference to FIG. 7, showing safety features of ladder 10 including the option magnetized metal cuff 55 that manually slides over rung 5, and abuts moveable rail 3, to secure moveable rail 3 via magnetism to flange 4. Additionally, moveable rail 3 when abutting flange 4 will allow safety pin 52 to be engaged and slide up through a hole in rung 5 to prevent moveable rail 3 from moving during engagement. Safety pin 52 can be engaged by push pin operation or moveable lever.

With reference to FIG. 8, showing the magnetized metal cuff 55 moving over rung 5 to abut moveable rail 3 and come into contact with the magnet 57 inside flange 4. As noted above, this ladder can be expanded or collapsed further by use of barrel hinge 20 which allows the rail 3 to fold over.

In general reference to FIG. 1, ladder 10 will generally come in sections that may be expanded with use of a hinge mechanism 20 that allow the ladder to double in size when engaged. Hinge mechanism 20 consists of a barrel hinge 21 and a mechanism for securing such hinge to the ladder 10 such as screws. This is also shown in FIG. 8.

Reference throughout this specification to “one embodiment”, “an embodiment”, or “a specific embodiment” means that a particular feature, structure, or characteristic described in connection with the embodiment is included in at least one embodiment of the present invention and not necessarily in all its embodiments. Therefore, the respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of the illustrated embodiments of the present invention and are to be included within the spirit and scope of the present invention.

Therefore, while the present invention has been described herein with reference to the particular embodiments thereof, a latitude of modification, various changes and substitutions are intended in the foregoing disclosures, and it will be appreciated that in some instances some features of the embodiments of the invention will be employed without the corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A collapsible ladder comprising:
A stable supporting rail that is affixed to rungs;
A movable rail that is capable of sliding over the rungs to meet the stable rail;
Rungs that are affixed to the supporting rail using a pivoting mechanism that is capable of bending only in one direction and having a oversized knob on the end abutting the movable rail to prevent the movable rail from exceeding the length of the rung;
Said pivoting mechanism that affixes to the rungs to secure it both to the supporting rail and the rung and having a mechanism that allows the mechanism to bend in a single direction upwards allowing the rung to fold upward upon collapse of the ladder;
A connecting mechanism located at the end of every section of ladder that operates to extend and connect ladder sections and folds to allow the ladder to move fully collapse into sections;
Said connecting mechanism consists of a hinge and securing mechanism that attaches the hinge to each section of ladder.

2. A collapsible ladder as defined in claim 1 wherein a magnetized metal cuff or other magnetized securing device fit over the rungs to secure the moveable rail to the oversized rung knob.

3. A collapsible ladder as defined in claim 1 wherein the movable rail has a pin-like securing device within the rail that operates to secure the moveable rail to rung.

4. A method for collapsing a ladder comprising:
sliding a moveable rail along a rung and towards a second stable rail until said first rail passes over a part of a knuckle assembly and is generally flushed against the second rail; and
pivoting the rung into a generally parallel position with respect to the first and second rail.
